(19) United States
(12) Patent Application Publication
(10) Pub. No.: US 2005/0186122 A1
(43) Pub. Date: Aug. 25, 2005

(54) Molded container

(76) Inventors: James D. Mercer, Howe, TX (US); John W. Baker, Desoto, TX (US); Rudolfo Diaz JR., Dallas, TX (US); Scott E. Bennefeld, Plano, TX (US); George Grigorow, Mansfield, TX (US); Mark W. McElhinny, Mesquite, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/783,546

(22) Filed: Feb. 20, 2004

(51) Int. Cl. B01L 9/00

(52) U.S. Cl. 422/104

(57) ABSTRACT

A molded container may include a unitary base. The base may include projections designed to secure, support, position, and/or protect one or more objects held in the molded container. The projections may be spaced to allow access to objects held in the base. The projections may include ledges and/or lips. A molded container may include a lid. An inner surface of the lid may have protrusions to hold objects in place in the molded container. Closure portions of the lid may snap securely on the base. A lid may be attached to a base or removable. A separate lid may include guides to facilitate placement of the lid on the base. In an embodiment, a base of a molded container may fit in the lid of the molded container. A lid and/or a base of a molded container may be designed to allow stacking of two or more molded containers.

### BACKGROUND

1. Field of Invention

The present invention generally relates to a molded container for holding one or more objects. In particular, the invention relates to a molded container including a unitary base designed to secure, support, position, and/or protect objects in the molded container during shipping, handling, and/or storage.

2. Description of Related Art

Multi-compartment containers have been formed to hold objects. One type of container includes a thermoformed tray that is placed in a separately molded container. The separately molded container may include a hinged lid. The thermoformed tray may be made by a process of preheating a sheet of plastic until the sheet is pliable. The sheet may be placed over a thermoforming open mold with an array of pockets. A vacuum source may be used to draw the sheet into the pockets to form the thermoformed tray. The thermoformed tray may be placed within the separately molded container. An object, such as a computer chip, may be held by friction in a compartment of the tray. In some embodiments, the tray may be able to move within the container. In some embodiments, the object may release from the compartment during handling. In some embodiments, a filler may be placed in the container to inhibit release of objects from compartments.

### SUMMARY

A molded container is formed to hold objects. Objects held in the molded container may remain secure in compartments during handling, conveying, storage, and/or shipping. The compartments of the molded container are formed as part of the container. Having the compartments formed as part of the container eliminates the need to make a separate tray mold and eliminates the manufacturing and assembly cost associated with the separate tray.

In some embodiments, molded containers may be used to hold fragile, precisely manufactured, and/or high tolerance objects. The objects may be machined tool parts, electronic components and/or optical components. In certain embodiments, a molded container may be used to hold one or more semiconductor wafers and/or computer chips. In general, molded containers may be used to hold one or more objects in a fixed position relative to a portion of the container. In some embodiments, an object in a molded container may be held a distance above an inner surface of the container. Objects held in molded containers may be inhibited from contacting each other.

In an embodiment, a molded container may include a base. In some embodiments, a molded container may include a base and a lid. A lid may be attached to a base or the lid may be removable from the base. In certain embodiments, an inner surface of a lid of a molded container may include protrusions designed to inhibit movement of objects in the molded container. In certain embodiments, closure portions of a lid may allow the lid to be secured to a base of a molded container. Securing the lid to the base of the molded container may promote retention of objects in the molded container. Securing the lid to the base may protect objects in the molded container from environmental factors including, but not limited to, dust and moisture.

A molded container may include projections designed to secure, support, position, and/or protect an object in the molded container. The projections may extend from the base of the molded container. In some embodiments, a molded container may include projections of uniform size and/or shape. For example, uniform projections in the molded container may be designed to secure, support, and/or position an object. In certain embodiments, a molded container may include projections of various sizes and or shapes. Projections of a molded container may include supports and retainers. Some projections may be shaped and/or sized to position and/or support an object in the molded container. Other projections may be shaped and/or sized to secure and retain the object in compartments of the molded container. In an embodiment of a molded container designed to hold objects of various sizes and/or shapes, projections may be sized and/or shaped differently for each object or for each group of similar objects.

Supports of a molded container may be formed when the molded container is formed. The supports may be rigid or semi-rigid mounts that contact a lower surface of an object positioned in a compartment of the molded container. The supports may define a compartment for an object to be placed in the molded container. The supports may include sides that inhibit lateral movement of the object when the object is positioned in the compartment. The supports may have enough flexibility to inhibit application of force sufficient to remove or damage an object in the compartment should the molded container be jostled, dropped, impacted, or otherwise subjected to force that could disturb the object.

A retainer may be a spring-like cantilever extending from a bottom of the molded container. One or more retainers may be used to hold an object in a compartment of a molded container. In some embodiments, the retainer may include an extension or protrusion. When an object is placed in a compartment, a retainer may bend outwards until the extension or protrusion passes an upper surface or lip of the object. When the upper surface or lip passes the extension or protrusion, the retainer may bend inwards towards an original position. The extension or protrusion may form an interference fit with the object to inhibit vertical movement of the object in the compartment, including undesired removal of the object from the compartment. In some embodiments, the retainer may not include an extension or protrusion. A friction connection between the object and the retainer may inhibit undesired removal of the object from the compartment when the retainer does not include an extension or protrusion.

In some embodiments, projections in a molded container may be located to facilitate access to objects held in the molded container. For example, projections may be located to achieve a desired spacing between objects and/or between an object and an edge of the molded container. A desired spacing between objects and/or between an object and an edge of the molded container may allow handling of the object by a person and/or machine while inhibiting damage of other objects proximate the object being handled.

In some embodiments, a base and/or a lid of a molded container may be designed to allow stacking of two or more molded containers. For example, an outer surface of a lid for a molded container may include one or more raised and/or recessed portions designed to mate with one or more recessed and/or raised portions, respectively, of an outer surface of a base of another molded container. Stacking of molded containers may be desirable during storage and/or shipping of the molded containers.

### BRIEF DESCRIPTION OF THE DRAWINGS

Advantages of the present invention will become apparent to those skilled in the art with the benefit of the following detailed description and upon reference to the accompanying drawings in which:

FIG. 1 depicts a perspective view of an embodiment of a molded container with a base and a removable lid.

FIG. 2 depicts a bottom view of a base of an embodiment of a molded container.

FIG. 3 depicts an enlarged portion of the base depicted in FIG. 1.

FIG. 4 depicts an embodiment of a retainer for a base of a molded container.

FIG. 5 depicts an embodiment of a retainer for a base of a molded container.

FIG. 6 depicts an embodiment of a retainer for a base of a molded container.

FIG. 7 depicts an embodiment of a retainer for a base of a molded container.

FIG. 8 depicts a cross-sectional view of a portion of an embodiment of a base of a molded container with an object positioned in a compartment of the molded container.

FIG. 9 depicts a cross-sectional view of a portion of an embodiment of a base of a molded container.

FIG. 10 depicts a perspective view showing an inner surface of the lid depicted in FIG. 1.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

A molded container may be formed in an injection-molding process using polymers including, but not limited to, polypropylene, polyamide, polycarbonate, polyesters, polybutylene terephthalate, polyvinylchloride, styrenes, acrylonitrile butadiene styrene, or mixtures thereof. A molded container may include a base and a lid. In some embodiments, the base of the molded container may be made of the same material as is used to form the lid of the molded container. In some embodiments, the base of the molded container may be made of a different material than the material used to form the lid of the molded container. In some embodiments, a mold used to form a molded container using an injection molding process may simultaneously form both a base and a lid.

In some embodiments, a polymer used to form a molded container may include one or more additives. Additives may be included in polymers used to form a molded container to change properties of the container including, but not limited to, color, texture, and conductive properties. A color of a molded container may be chosen for visual identification of objects held in the container. Texture of a molded container may be chosen to enhance handling, conveying, and/or storing characteristics of the molded container.

Conductive properties of a molded container may be altered by one or more additives. The ability of a molded container to dissipate electricity at a desired rate may be very important if the molded container is to hold electric components that could be damaged by static electric charges or other electric charges that could pass to the electric components when the components are held in the molded container. Conductive additives may be introduced or withheld so that the molded container has the ability to dissipate electric charges at a desired rate. In a test for measuring dissipative properties of a molded container, a charge (such as a 100 volt charge) may be applied to the molded container by a test device. After application of the charge, the test device may take a surface resistance measurement to determine if the molded container dissipated the applied charge sufficiently. For example, after application of the charge, a surface resistance reading in a range from about 10⁻³ to about 10⁻¹⁵ ohms may indicate acceptable dissipative properties. In certain embodiments, a desirable surface resistance reading after application of the charge may be in a range from about 10⁻⁶ to about 10⁻¹¹ ohms. In some embodiments, the molded container may be formed of an electrically insulating material. In some embodiments, the molded container may be formed of an electrically conductive material. The amount of additives and/or the type of polymer used to form the molded container may be chosen so that the molded container has a desired electrical discharge rate.

In some embodiments, metallic or other conductive material may be molded into the molded container base and/or the molded container lid as a conductive ground connector to form an electrical pathway to electrical ground. In some embodiments, the metallic or other conductive material may be coupled to the molded container base and/or lid after the molded container is formed. In some embodiments, the ground may be a metallic button with a shank that passes through the wall of the lid or base so that the ground is able to contact an external connection to ground during use of the molded container.

In some embodiments, a molded container may be designed to hold (e.g., inhibit vertical and/or lateral movement of) two or more objects of the same size and/or shape. In certain embodiments, a molded container may be designed to hold two or more objects of various sizes and or shapes. For example, a molded container may be designed to hold pieces of a kit or components of a system (e.g., a chip set for a computer system). In an embodiment, a molded container may be designed to hold objects that have substantially regular shapes, including, but not limited to, square, rectangular, or circular shapes. In some embodiments, a molded container may be designed to hold objects with irregular shapes including, but not limited to, tools, equipment, and electronic components. In certain embodiments, an object may be held in a molded container such that sides of the object with the largest surface are substantially parallel to a bottom surface of the base of the molded container and/or a top surface of the lid of the molded container.

Projections in a molded container may be located as desired to hold objects of various sizes and/or shapes. For example, projections in a molded container may be located to allow efficient positioning of objects in the molded container. For example, projections in a molded container designed to hold square or rectangular objects may be aligned in one or more dimensions, such that edges of like objects held in the molded container are aligned. Projections in a molded container designed to hold circular objects may be positioned around a circumference of a circle of the desired size or sizes.

In some embodiments, a molded container may be formed as a single piece including a base and a lid (e.g., a hinged lid). In certain embodiments, a molded container may be formed as two pieces including a unitary base and a removable lid. Limiting the number of components of a molded container may advantageously reduce the cost of manufacturing the container. In some embodiments, a removable lid may include one or more guides to facilitate rapid, accurate placement of the lid on the base of the container. A molded container with a removable lid may advantageously allow easier access to objects in the container and require less workspace than a molded container with an attached lid. A removable lid may be sized and/or shaped such that the base of the open molded container may fit on an inner surface and/or an outer surface of the lid. In some embodiments, a raised portion of the lid may fit in a recessed portion of the base to connect the base and lid when the lid is not being used to cover the molded container. In some embodiments, a raised portion of the base may fit in a recessed portion of the lid to connect the base and lid when the lid is not being used to cover the molded container. Connecting the lid to the base may allow the lid to remain associated with the base when the lid is not being used to close the molded container.

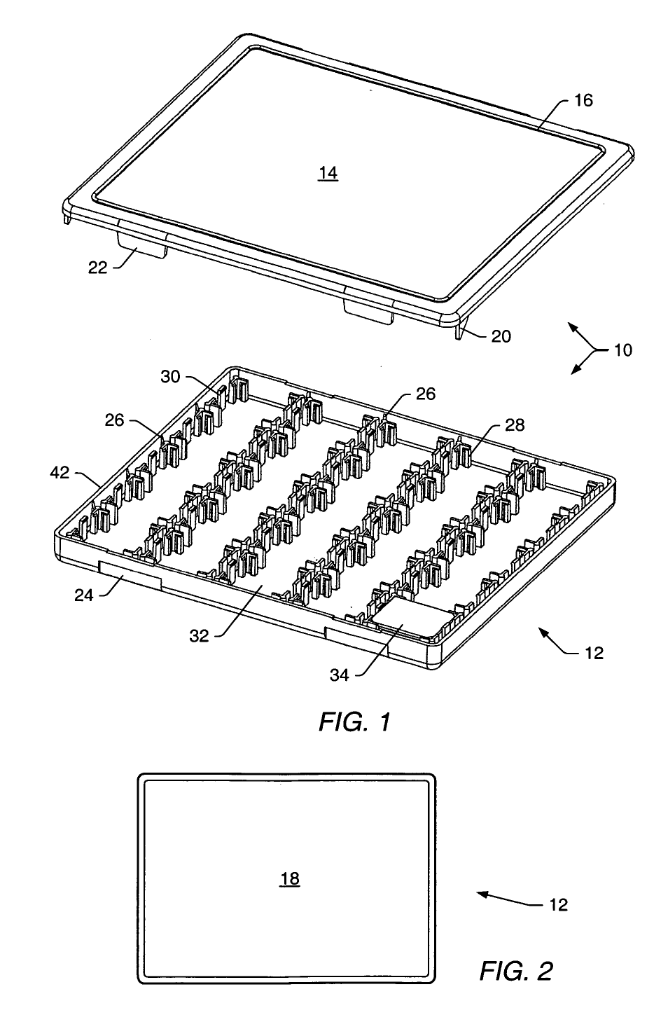

FIG. 1 depicts a perspective view of components of an embodiment of a molded container with a removable lid. Molded container 10 may include base 12 and lid 14. In some embodiments, the top surface of lid 14 may include one or more raised portions 16. Raised portion 16 may be sized and/or shaped to fit into one or more recesses 18 (shown in FIG. 2) on the bottom of base 12. In some embodiments, base 12 may be placed on top of lid 14 such that one or more raised portions 16 are seated in one or more recesses on the bottom of base 12. Seating raised portions 16 in recess 18 may allow lid 14 to remain associated with base 12 when the lid is not being used to close the molded container. Seating raised portions 16 in recess 18 may inhibit lateral movement of base 12 relative to lid 14. In some embodiments, lid 14 may be placed upside down on base 12 such that raised portions 16 of the lid fit inside the opening of the base, inhibiting lateral movement of stacked molded containers 10. In certain embodiments, molded containers 10 may be stacked such that one or more raised portions 16 of a first closed molded container are seated in one or more recesses on the bottom surface of a base of another molded container. In some embodiments, base 12 may include raised portions and lid 14 may include recessed portions to allow stacking of molded containers 10.

In some embodiments, lid 14 may include one or more guides 20. Guides 20 may facilitate alignment of lid 14 on base 12 during placement of the lid on the base. In certain embodiments, guides 20 may be molded proximate one or more outer edges and/or corners of lid 14.

In some embodiments, lid 14 may include one or more closure portions 22. Closure portions 22 may be designed to secure lid 14 to base 12. Closure portions may be of any design sufficient to inhibit unintentional opening of molded container 10. As depicted in FIG. 1, closure portion 22 may extend from an edge of lid 14. In some embodiments, closure portion 22 may include a lip designed to mate with and/or couple to closure portion 24 of base 12. In an embodiment, closure portion 24 of base 12 may be designed to receive closure portion 22 of lid 14. In some embodiments, closure portion 22 of lid 14 may be snapped to closure portion 24 of base 12. Closure portions 22 of lid 14 may be pried manually or otherwise from closure portions 24 of base 12 to allow the lid to be removed from the base. In certain embodiments, closure portions 24 of base 12 may include extensions and closure portions 22 of lid 14 may include recesses to accept closure portions 24 of the base. Closure portions may allow the lid to be fastened to the base. Closure portions of the lid and base may include fasteners such as, but not limited to, snaps, clasps, latches, screws and/or threaded openings, and locks. Closure portions may be used with or without a gasket to promote a seal between a lid and a base. In some embodiments, after one or more objects are positioned in a molded container, the lid may be sealed to the base by glue, sonic welding, or other method to inhibit removal of the objects from the molded container until the molded container reaches a final destination.

Base 12 may include ribs 26 and projections. Ribs 26 may strengthen and stabilize base 12. Projections of base 12 may include supports 28 and retainers 30. Projections may extend from inner surface 32 of base 12. Projections may be located as desired in base 12 to hold objects of various sizes and/or shapes. Projections may be of any shape, size, and/or design to secure, support, and/or position one or more objects 34 of various and/or similar sizes and/or shapes in base 12. The projections may define compartments for holding objects 34. In some embodiments, one or more different types of projections 28 may be used to hold object 34 in base 12.

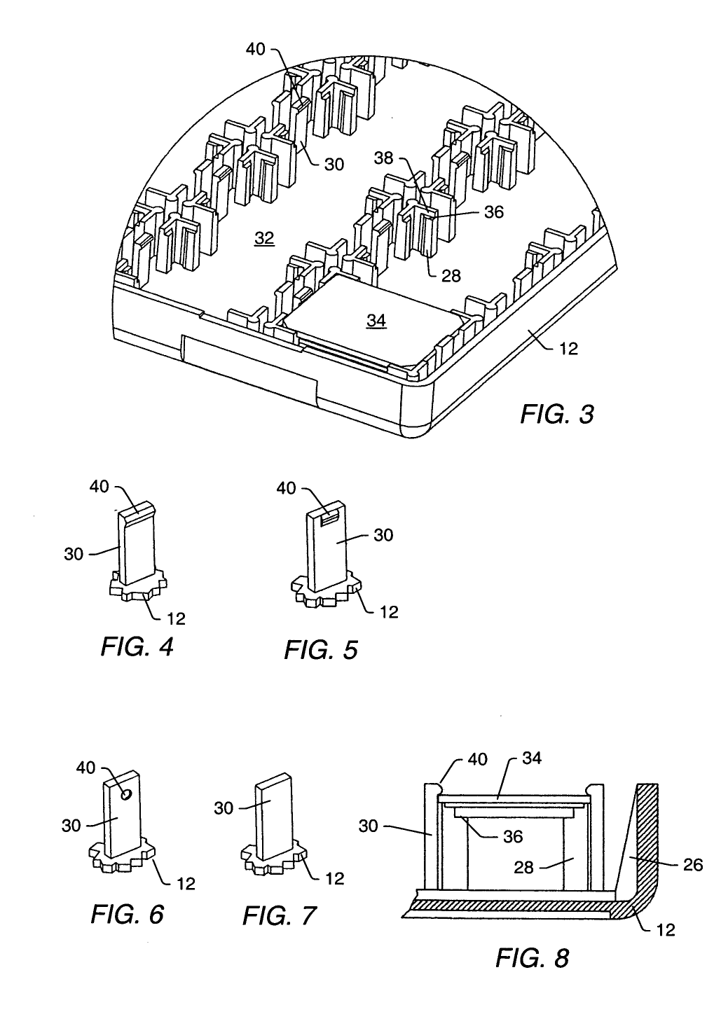

FIG. 3 depicts a detailed perspective view of a portion of base 12 depicted in FIG. 1. As shown in FIG. 3, support 28 may include one or more ledges 36. Ledges 36 may be designed to hold object 34 a distance above inner surface 32 of base 12. Support 28 may include corners designed to facilitate positioning of object 34 in molded container 10. Side walls 38 of support 28 may define a compartment for an object to be held in a molded container. Side walls 38 may inhibit lateral movement of an object that rests on ledges 36 of support 28. As shown in FIG. 3, supports 28 are positioned at locations that substantially correspond to corners of an object to be held in the molded container. In some embodiments, supports may be positioned to contact other portions of an object to be held in a molded container.

In some embodiments, retainers 30 may be cantilevered extensions from inner surface 32 of base 12. In some embodiments, a height of retainers 30 may exceed a height of supports 28. An upper portion of retainer 30 may be designed to inhibit unintentional removal of object 34 from a molded container. In some embodiments, an upper portion of retainer 30 may include lip 40. As shown in FIG. 4, lip 40 may extend a full width of retainer 30. As shown in FIG. 5, lip 40 may extend across a portion of a width of retainer 30 in some embodiments. As shown in FIG. 6, lip 40 may be a rounded bump in some embodiments. In other embodiments, the lip may be another type of protrusion extending from a surface of the retainer. When an object is placed in a compartment of a molded container, the object may contact lip 40 and bend retainer 30 outwards. When a surface of the object passes lip 40, retainer 30 may return towards an initial position. An interference fit may be formed between the object and lip 40 to inhibit unintentional removal of the object from the molded container.

As shown in FIG. 7, retainer 30 may not include a protrusion in some embodiments. Retainer 30 may hold an object by a frictional connection between the retainer and the object. In some embodiments, retainer 30 may include a textured surface to enhance frictional contact between the retainer and the object.

FIG. 8 depicts a cross-sectional view of a portion of a base of a molded container. Object 34 is seated in a compartment of the molded container. Flexibility of retainers 30 may allow object 34 to be snapped into place in base 12. Snapping object 34 into place may include pushing the object past lips 40, increasing a distance between upper portions of retainers 30, and seating the object on the ledges 36 of supports 28. After object 34 has been pushed past lips 40 and seated on ledges 36 of supports 28, the original distance between upper portions of retainers 30 may be restored. Lips 40 may extend over a portion of the surface of object 34 to form an interference fit that inhibits unintentional removal and/or insertion of object 34 from the molded container by a person and/or by robotic methods. Object 34 may be removed from base 12 by exerting outward pressure or force on retainers 30. The outward pressure or force may be exerted by grasping the object and moving the object upwards, away from retainers 30. The object may be grasped with fingers. If it is desired to avoid human contact with the object, the object may be removed using a vacuum suction cup device or a grasping device (e.g., pliers).

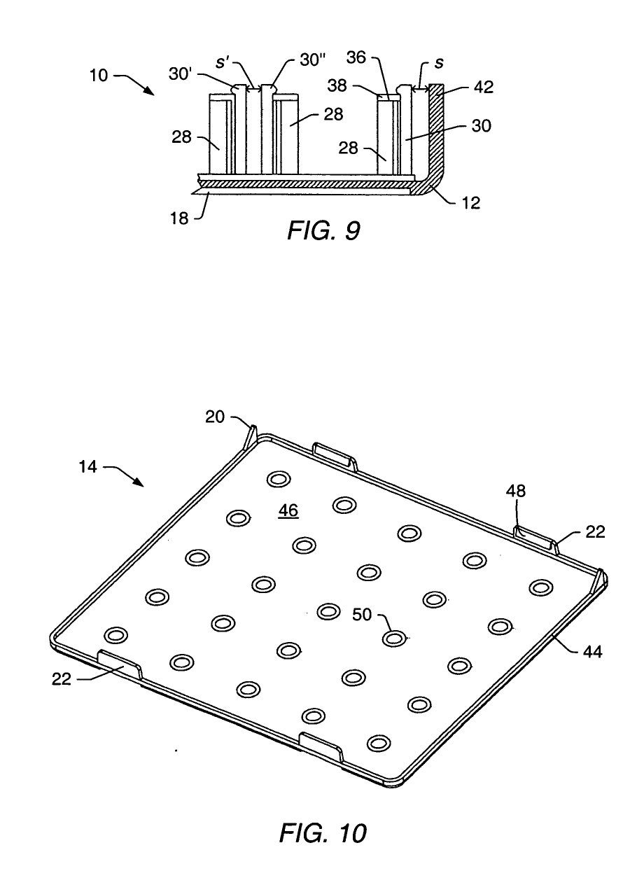

As depicted in FIG. 1, projections, such as supports 28 and retainers 30, may be located a distance from an inner surface of edge 42 of base 12. A spacing between the projections and an inner surface of edge 42 of base 12 may allow objects to be placed in the base or removed from the base with fingers, suction tools, grasping devices, etc. FIG. 9 depicts a cross-sectional view of a portion of a base of a molded container. In certain embodiments, a spacing s between projection 28 and an inner surface of edge 42 of base 12 may range as needed to achieve a desirable spacing for various objects. In some embodiments, a spacing s may range from about 0.1 cm to about 12 cm. For example, spacing s may be about 0.5 cm. FIG. 9 also depicts recess 18. Recess 18 is sized to accept raised portion 16 of lid (shown in FIG. 1).

As depicted in FIG. 1, projections, such as supports 28 and retainers 30, for holding a first object may be located a distance from projections for holding a second object. The spacing between projections for holding the first object and projections for holding the second object may allow the edges of the objects to be grasped during insertion of the objects in molded container 10 or during removal of the objects from the molded container. FIG. 9 depicts spacing s′ between retainer 30′ for holding a first object and retainer 30″ for holding a second object proximate the first object. Spacing s′ may allow handling or processing of the objects while the objects are held in molded container 10. Spacing s′ may allow room for retainers 30 to flex as objects are inserted in a molded container and/or removed from a molded container. Spacing s′ may be advantageously selected for various molded containers and/or objects. For example, spacing s′ may range from about 0.1 cm to about 12 cm. In some embodiments, s′ may be about 0.5 cm. In certain embodiments, projections may be used to hold two or more objects simultaneously.

FIG. 10 depicts a perspective view of an inside surface of the removable lid shown in FIG. 1. As depicted in FIG. 10, lid 14 may include edge 44. Lid 14 may be sized such that a portion of edge 44 overlaps at least a portion of an outer surface of edge 42 of base 12 (shown in FIG. 1) when the lid is secured on the base. Overlap of edge 44 with an outer surface of edge 42 of base 12 may inhibit damage of objects held in a molded container from environmental factors including, but not limited to, moisture and dust. In certain embodiments, substantially all of an upper surface of edge 42 of base 12 (depicted in FIG. 1) may contact inner surface 46 of lid 14 when the lid is secured on the base. In some embodiments, edge 44 of lid 14 and edge 42 of base 12 may have substantially the same shape and circumference, such that the edges abut when the lid is placed on the base. In certain embodiments, a gasket may be positioned between a surface of edge 44 of lid 14 and a surface of edge 42 of base 12 to promote sealing of the molded container when the lid is secured on the base.

In some embodiments, base 12 of molded container 10 (depicted in FIG. 1) may fit within edge 44 of lid 14. Lid 14 may be placed such that an outer surface of the lid is on a work surface. Base 12 may be placed within edge 44 of the lid 14 such that an outer surface of the base is resting on at least a portion of inner surface 46 of the lid. In certain embodiments, base 12 may be placed within edge 44 of the lid 14 such that an outer surface of the base is resting on one or more protrusions extending from an inner surface of the lid. Placing base 12 on lid 14 allows the base to be associated with the lid when the lid is not used to cover the base. Placing base 12 on lid 14 may allow a large contact area between the lid and the work surface.

In some embodiments, an upper surface of edge 42 of base 12 may include protrusions and/or recesses to mate with recesses and/or protrusions, respectively, on a bottom surface of another base to allow stacking of two or more bases without lids. For example, an upper surface of edge 42 of base 12 may include protrusions designed to mate with recesses in a bottom of another base, or a bottom of base 12 may include protrusions designed to mate with recesses in an upper surface of edge 42 of another base. Stacking of bases without lids may allow more efficient use of workspace and/or promote more efficient access to objects stored in molded containers.

In some embodiments, guides 20 may be molded at one or more locations on lid 14. Guides 20 may be sized and/or shaped to facilitate alignment of lid 14 on base 12 of molded container 10. In certain embodiments, guides 20 may be sized and/or shaped such that the guides do not increase a width of lid 14. In some embodiments, closure portion 22 of lid 14 may include lip 48. Lip 48 may include an angled barb. Closure portion 22 and lip 48 may be sized and/or shaped to snap over an upper edge of closure portions 24 of base 12 (shown in FIG. 1). Lip 48 may allow lid 14 to be coupled securely to a base of a molded container.

Inner surface 46 of lid 14 may include protrusions 50. Protrusions 50 may promote retention of objects in the base of a molded container. Protrusions 50 may inhibit dislodging of objects in the base of a molded container if the molded container is shaken, jarred, or dropped. Protrusions 50 may be located on inner surface 46 of lid 14 such that each protrusion is substantially above an object (or a space designed to hold an object) in a base of a molded container when the lid is secured to the base. In some embodiments, a single protrusion 50 may extend toward a single object held in a molded container. The single protrusion 50 may be substantially centered above the object. In certain embodiments, two or more protrusions 50 may extend toward a single object held in a molded container. The two or more protrusions 50 may be located as desired above the object. In certain embodiments, protrusions 50 may touch or almost touch upper surfaces of objects when lid 14 is secured to the base of a molded container.

Protrusions 50 molded in lid 14 may be shaped and/or sized as desired in accordance with objects to be held in a molded container. In some embodiments, as depicted in FIG. 10, protrusions 50 may be in the form of a ridge. In certain embodiments, protrusions 50 may be uniform raised portions. For example, protrusions 50 may be solid circular raised portions. Protrusions 50 in lid 14 may have one or more shapes including, but not limited to, square, rectangular, circular, triangular, and star-shapes. In some embodiments, protrusions may be spaced-apart ridges that span across a width or length, or a portion thereof, of the lid. In some embodiments, protrusions 50 in lid 14 may have various heights, designed to accommodate various objects held in the base. In certain embodiments, a height of protrusion 50 may vary along the protrusion to accommodate an uneven surface of an object.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A container, comprising:
an injection molded, unitary base comprising:
supports configured to hold an object and inhibit lateral movement of the object; and
cantilevered retainers configured to inhibit unintentional removal and vertical movement of the object when the object is positioned between the retainers and on the supports.

2. The container of claim 1, wherein at least one of the cantilevered retainers comprises a protrusion, and wherein the protrusion is configured to form an interference fit with the object to inhibit unintentional removal of the object from the supports.

3. The container of claim 1, wherein at least one of the cantilevered retainers comprises a textured surface configured to inhibit removal of the object from the supports.

4. The container of claim 1, wherein the unitary base comprises an electrically insulative polymer.

5. The container of claim 1, wherein the unitary base comprises an electrically conductive polymer, wherein the polymer is configured to dissipate an electrical charge at a desired rate to inhibit damage to an object in the container.

6. The container of claim 1, wherein the unitary base comprises a conductive ground connector to facilitate coupling the base to electrical ground.

7. The container of claim 1, further comprising a lid configured to couple to the unitary base to close the container.

8. The container of claim 1, further comprising a lid configured to couple to the unitary base to close the container, wherein a portion of a bottom surface of the unitary base is configured to couple to a portion of an upper surface of the lid.

9. The container of claim 1, further comprising a lid configured to couple to the unitary base to close the container, and a fastener configured to secure the lid to the base.

10. The container of claim 1, further comprising a lid configured to couple to the unitary base to close the container, and wherein the lid comprises at least one protrusion configured to inhibit removal of an object from the supports when the lid is coupled to the unitary base.

11. The container of claim 1, further comprising a lid configured to couple to the unitary base to close the container, and wherein the lid and the unitary base comprise alignment guides to facilitate coupling the lid to the unitary base.

12. A container for holding a plurality of objects, comprising:
an injection molded, unitary base comprising:
a plurality of sets of supports, wherein each set of supports is configured to form a compartment for holding an object; and
at least one cantilevered retainer for each compartment.

13. The container of claim 12, wherein the plurality of sets comprises a first set of supports configured to hold a first object, and a second set of supports to hold a second object, and wherein the first object has substantially the same shape as the second object.

14. The container of claim 12, wherein the plurality of sets comprises a first set of supports configured to hold a first object, and a second set of supports to hold a second object, and wherein the first object has a substantially different shape than the second object.

15. The container of claim 12, wherein at least one of the cantilevered retainers comprises a protrusion, and wherein the protrusion is configured to form an interference fit with an object coupled to a set of supports to inhibit removal of the object from the supports.

16. The container of claim 12, wherein at least one of the cantilevered retainers comprises a textured surface configured to inhibit removal of an object coupled to a set of supports.

17. The container of claim 12, wherein the unitary base comprises an electrically insulative polymer.

18. The container of claim 12, wherein the unitary base comprises an electrically conductive polymer, wherein the polymer is configured to dissipate an electrical charge at a desired rate to inhibit damage to an object in the container.

19. The container of claim 12, wherein the unitary base comprises a conductive ground connector to facilitate coupling the base to electrical ground.

20. The container of claim 12, further comprising a lid configured to couple to the unitary base to close the container.

21. The container of claim 12, further comprising a lid configured to couple to the unitary base to close the container, wherein a portion of a bottom surface of the unitary base is configured to couple to a portion of an upper surface of the lid.

22. The container of claim 12, further comprising a lid configured to couple to the unitary base to close the container, and a fastener configured to secure the lid to the base.

23. The container of claim 12, further comprising a lid configured to couple to the unitary base to close the container, and wherein the lid comprises at least one protrusion configured to inhibit removal of an object from the supports when the lid is coupled to the unitary base.

24. The container of claim 12, further comprising a lid configured to couple to the unitary base to close the container, and wherein the lid and the unitary base comprise alignment guides to facilitate coupling the lid to the unitary base.

25. A method of storing an object in a container having an injection molded, unitary base, comprising:
grasping the object;
positioning the object above a support;
forcing the object past a retainer to seat the object on the support; and
inhibiting removal of the object from the support by an interference connection between a portion of the retainer and a portion of the object.
